(19) United States
(12) Patent Application Publication
(10) Pub. No.: US 2006/0190329 A1
(43) Pub. Date: Aug. 24, 2006

(54) System and method for facilitating product placement advertising

(75) Inventors: Betsy A. Green, Marina del Rey, CA (US); Sally Green Cameron, McKinney, TX (US)

Correspondence Address: Baker & Daniels, Ste. 700, 805 15th Street, N.W., Washington, DC, 20005, US

(73) Assignee: Velocity Software Systems, Inc., Marina del Rey, CA (US)

(21) Appl. No.: 11/335,705

(22) Filed: Jan. 20, 2006

Related U.S. Application Data
(63) Continuation-in-part of application No. 10/888,825, filed on Jul. 9, 2004.
(60) Provisional application No. 60/485,397, filed on Jul. 9, 2003.
(60) Provisional application No. 60/535,810, filed on Jan. 13, 2004.

(51) Int. Cl. G06Q 30/00

(52) U.S. Cl. 705/14

(57) ABSTRACT

According to one aspect of the present invention, there is provided a computer-implemented system for facilitating product placement advertising. The system may include a user registration module including an account type selection component for allowing a user to select one of a buyer account and a seller account, wherein a buyer account allows product posting and a seller account allows program posting. The system may additionally include a program posting module for allowing sellers to post program information and a product posting module for allowing buyers to post product information. The system may further include a matching module for providing matching posted products upon entry of a program posting and for providing matching posted programs upon entry of a product posting.

### RELATED U.S. APPLICATION DATA

This application is a CIP of U.S. patent application Ser. No. 10/888,825, filed on Jul. 9, 2004, which claims priority to U.S. Provisional Application No. 60/485,397 filed Jul. 9, 2003; and U.S. Provisional Application No. 60/535,810 filed Jan. 13, 2004.

### BACKGROUND OF THE INVENTION

1. Field of the Invention

The present invention relates to a system and method for facilitating the efficient and timely use of product placement advertisements.

2. Description of the Related Art

Product placement is an advertising technique in which an advertised product is incorporated as part of the content of another product such as movie, video game, TV show, book, movie or even another advertisement. Product placement advertisement is growing field which has become increasingly more important as a source of revenue. This is particularly true in fields where viewing patterns and new technologies, such as Digital Video Recorders (DVRs), have made it easier and easier for consumers to skip over unwanted stand-alone advertisements.

As the value of product placement has increased, the number of opportunities for product placements have also increased through the use of digital editing. Many of these new digital editing techniques are well-know and discussed in U.S. Application Pub. No. US2003/0028432. Using such digital editing techniques, product placement advertisements can now be inserted at any time during the life a video product

Today, however, despite the increased value of product placements and the great number of product placement opportunities, buyer and sellers of product placement advertising have been unable to take advantage of the huge potential of this market. The primary obstacle to most product placement advertising is the speed of production and length of time required to negotiate product placement agreements. Using known techniques, the time required to identify and negotiate each product placement advertisement is not easily reduced because of the uniqueness of each product placement opportunity. Countless factors affect such negations and the slightest detail can alter the value of the product placement. Accordingly, each product placement advertisement generally requires a separate negotiation between each buyer and seller. This process is further slowed by the persistent difficulty of properly identify and contacting the right decision makers to negotiate each product placement opportunity and to turn it into a product placement advertisement.

Because of the difficulties described above, many, if not most, product placement opportunities today are not capitalized upon. Accordingly, what is needed is a new system which will enable sellers to quickly list product placement opportunities and for buyers to be able search and identify the right product placement opportunities for them. What is further needed is a system which will allow buyers and sellers to identify and contact the right decision makers to negotiate each product placement opportunity as they arise so that they can be quickly acted upon.

### SUMMARY OF THE INVENTION

According to one aspect of the invention, a computer-implemented system is provided for facilitating product placement advertising. The system may include a user registration module including an account type selection component for allowing a user to select one of a buyer account and a seller account, wherein a buyer account allows product posting and a seller account allows program posting. The system may additionally include a program posting module for allowing sellers to post program information and a product posting module for allowing buyers to post product information. The system may further include a matching module for providing matching posted products upon entry of a program posting and for providing matching posted programs upon entry of a product posting.

In an additional aspect, a computer-implemented method may be provided for facilitating product placement advertising.

The method may include providing a registration module for allowing users to enter biographical information and register for an account type, the account type including one of a program account and a product account. The method may additionally include offering a program posting module for allowing owners of a registered program account to post program information and a product posting module for allowing owners of a registered product account to post product information. The method may additionally include automatically producing matching products upon receipt of a program posting and automatically producing matching programs upon receipt of a product posting.

In yet a further aspect, a computer-implemented system may be provided for facilitating product placement advertising.

The system may include a program posting module for allowing sellers to post program information and a product posting module for allowing buyers to post product information. The system may additionally include a matching module for automatically providing matching posted products upon entry of a program posting and for automatically providing matching posted programs upon entry of a product posting. The system may further include a search module for allowing sellers to search for products to incorporate in a program by selected product criteria and allowing buyers to search for a program for feature of a product by entry of selected program criteria.

### BRIEF DESCRIPTION OF THE DRAWINGS

FIG. 1 is a simplified schematic representation illustrating one example of a computer network configuration for use with one embodiment of the present invention.

FIG. 2 is a simplified schematic representation illustrating one example of a computer system for use with one embodiment of the present invention.

FIGS. 3A-3F are block diagrams illustrating a system for facilitating product placement advertising in accordance with an embodiment of the invention;

FIGS. 4-17 show selected screen shots according to an exemplary embodiment of the present invention which illustrate selected aspects of the present invention.

FIG. 18 shows a general flowchart for the operation of one aspect of the present invention.

### DESCRIPTION OF THE PREFERRED EMBODIMENTS

Reference will now be made in detail to the exemplary embodiments of the invention, an example of which is illustrated in the accompanying drawings in which like reference characters refer to corresponding elements. Embodiments of the invention are directed to a system and method for matching sellers, such as program producers, with brands or products for the purpose of advertising or marketing. Embodiments of the invention are also directed to matching the buyers or marketers of products with a posted program. Preferably, the system and method of the present invention described below may be implemented by an interactive computer software application incorporated within a computer-readable medium such as a hard disk drive, an optical medium such as a compact disk, or the like. Further, the computer-readable medium may be available to a user either locally on the user's computer or remotely over a computer network, such as a local area network (LAN) or through the Internet.

In the preferred embodiment, the steps of the present invention are embodied in machine-executable instructions. These instructions can be used to cause a processor to perform the steps of the present invention. Alternatively, the steps of the present invention might be performed by hardware components, or by any combination of software and hardware components.

As a product, the present invention may be provided as software which may be used to program a computer (or other devices) to perform according to the present invention. As software, the present invention may be stored and transmitted to a variety of machine-readable medium including, for instance, RAM, EPROM, CD-ROM, ROMs floppy diskettes, optical disks, optical cards, or other type of media/machine-readable media.

Further, the present invention as software shall preferably be capable of being provided, transmitted and/or downloaded from a remote computer (i.e. a server) to a requesting computer (i.e., a client) via a communication link (e.g., a modem or network connection).

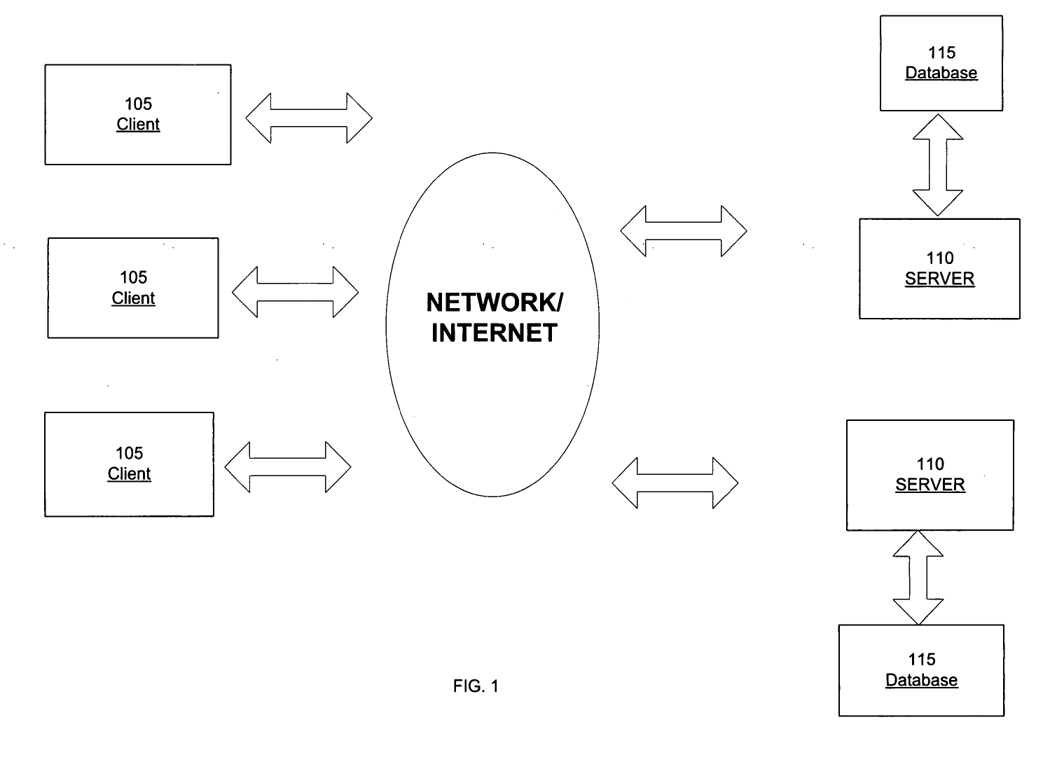

FIG. 1 is a simplified view of an exemplary client-server environment within which the present invention has been designed to optimally function. This architecture i s commonly know as the client-server model. The basic technology and structure of this model are discussed at length in Client/Server Architecture, 2^{nd} Ed., by Alex Berson (Magraw Hill 1996) which is incorporated by reference in its entirety to the present disclosure. It should be understood that the present invention operates independent of any particular arrangement or mix of network components and that FIG. 1 is purely illustrative and simplified for the purpose of explanation.

Within the client/server model, each client 105 acts as a requester of information; and each server 110 generally provides the data and services requested by each client 105. With reference to FIG. 1, clients 105 and servers 110 may communicate using a variety of protocols such as HyperText Transfer Protocol (HTTP). To access or request information, clients 105 may use a web browsers (i.e. Internet Explorer) to select a document by providing its Uniform Resource Locator (URL) to the servers 110. The URL may be entered manually or it may be sent by the user clicking on an embedded link containing the URL. In response to a selected URL, the web browser operates by forwarding a selected URL to the server 110, which in turn initiates a request for the document corresponding to the URL. The server 110 then transmits the requested document to the appropriate client 105 for viewing. Preferably, each server may have further access to internal and/or external databases 115 to allow for storing and retrieving information.

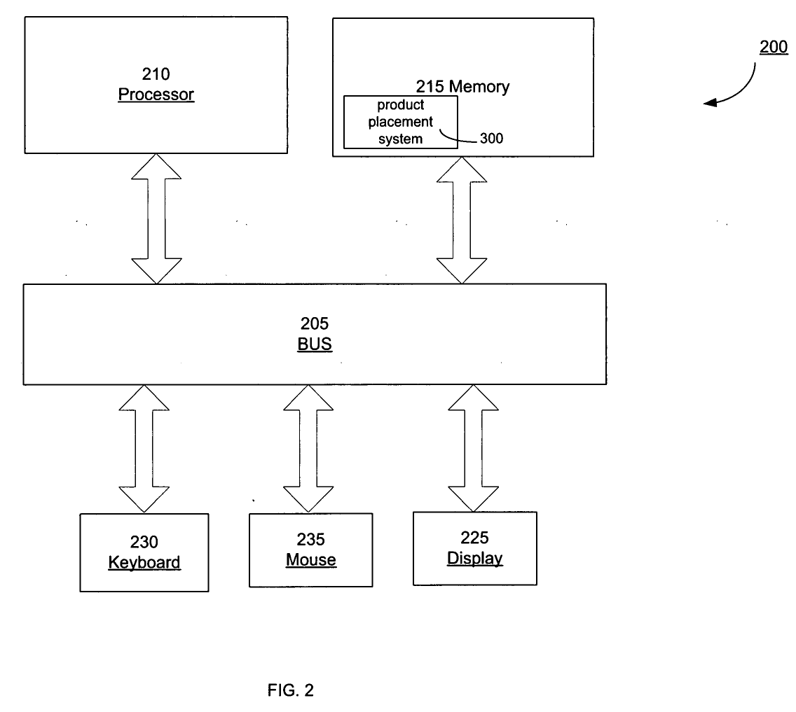

An exemplary computer system 200 in which features of the present invention may be implemented will now be described with reference to FIG. 2. Each of the servers 110 and clients 105 above may implement one or more computing systems having a structure such as that of computer system 200. As shown, computer system 200 comprises a bus 205 for communicating information internally within the computer system 200 and a processor 210 for processing information. The computer system 200 further comprises memory 215 for storing information and instructions to be executed by the processor 210.

The system memory 215 may include computer storage media in the form of volatile and/or nonvolatile memory such as read only memory (ROM) and random access memory (RAM). A basic input/output system (BIOS), containing the basic routines that help to transfer information between elements within the computer system 200, such as during start-up, is typically stored in ROM. RAM typically contains data and/or program modules that are immediately accessible to and/or presently being operated on by processor 210.

The RAM may include an operating system, program data and a variety of applications including a product placement system 300. The product placement system 300 and any other application programs stored in the system memory 215 may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including multiprocessor systems, microprocessor-based or programmable consumer electronics, minicomputers, mainframe computers, and the like.

The computer system 200 can also be coupled via a bus 205 to a display element 225 (i.e. a computer screen or monitor), for displaying information. Preferably, input devices such as a keyboard 230, mouse 235 along with other devices may also be coupled to a bus 205 for communicating information to the processor 210. Further, a modem (internal or external) or network interface device may be preferably used for allowing the computer system 200 to access the Internet or other computer networks.

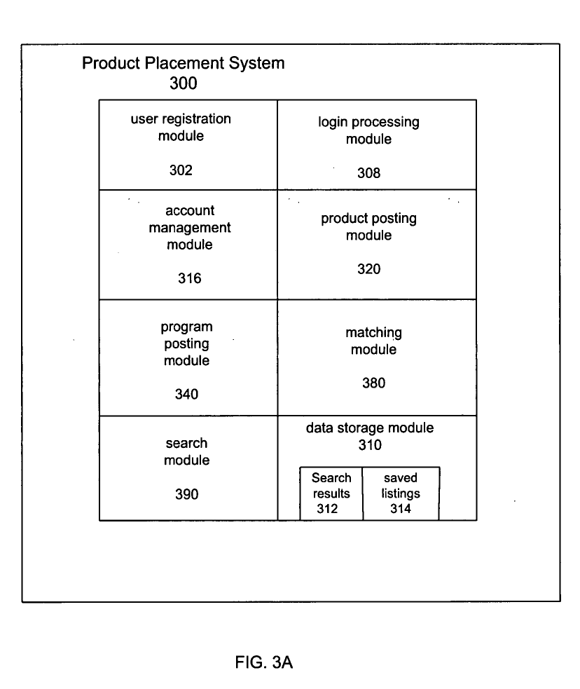

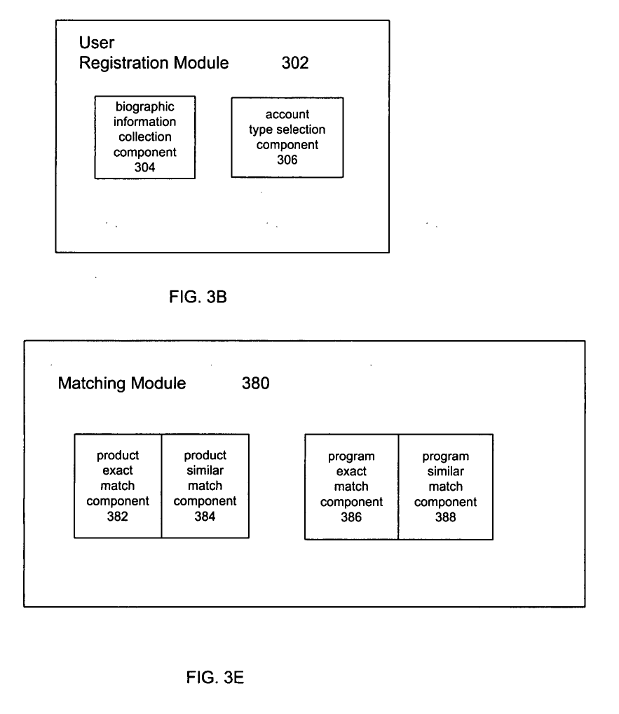

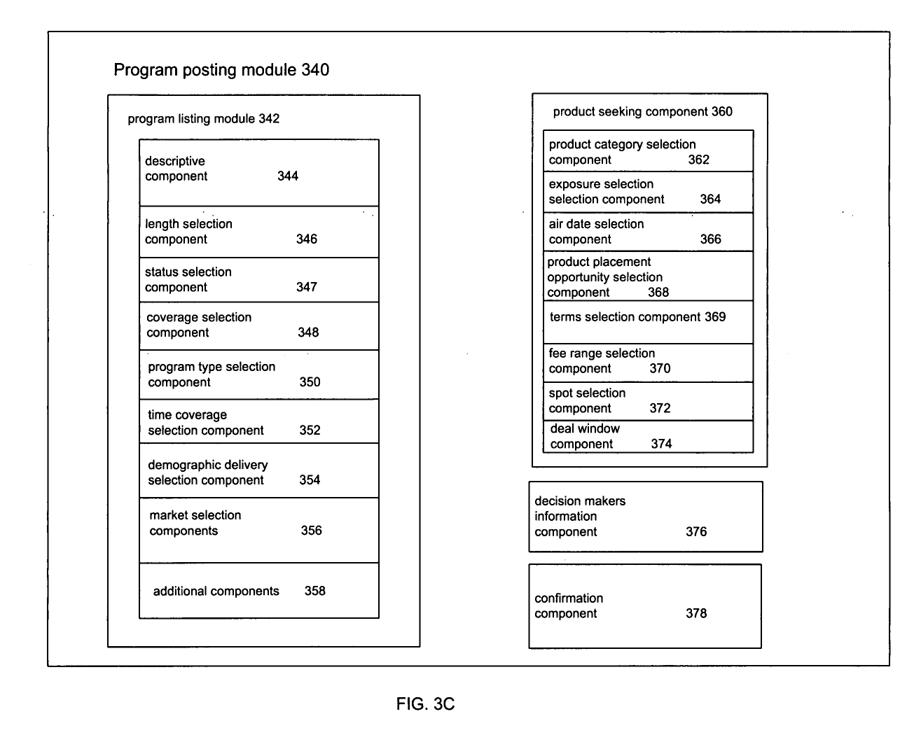

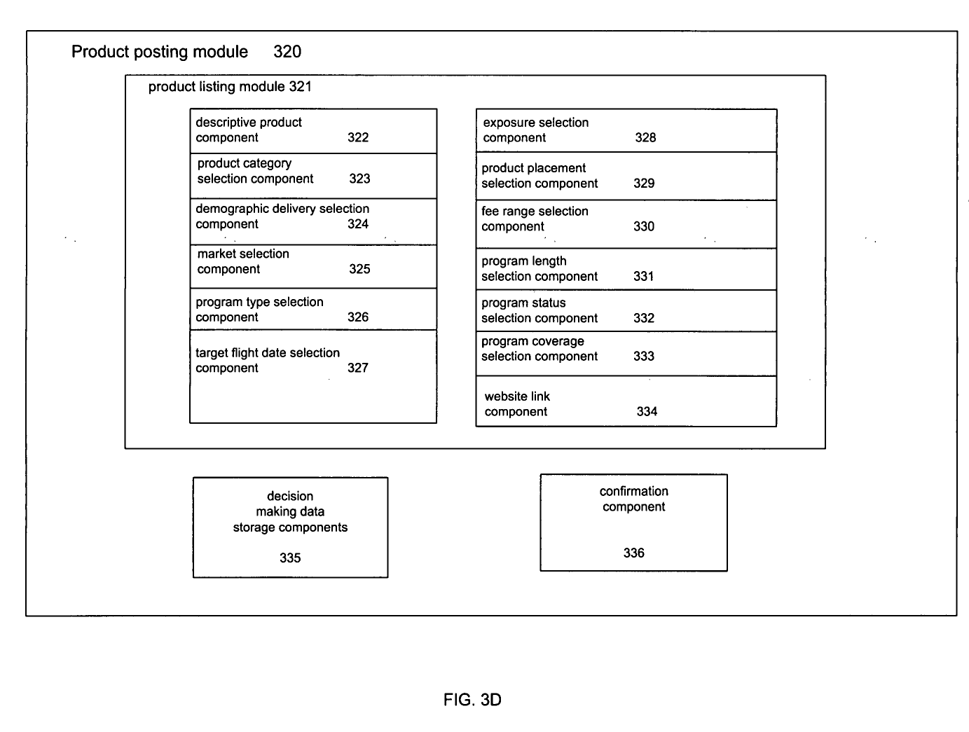

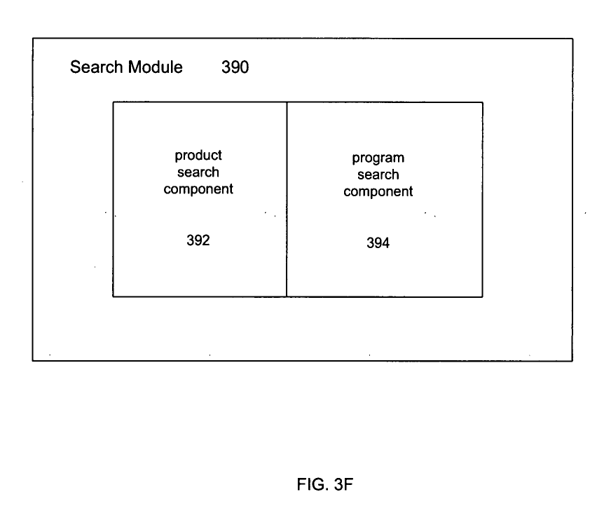

With reference now to FIGS. 3-18, an exemplary embodiment of the present invention will now discussed. As will be explained in detail below, the present invention allows sellers, such as television and film companies to advertise and make known the details of product placement opportunities which they wish to sell as product placement advertisements. The invention also allows buyers or product marketers to search for appropriate product placements.

Sellers may also include DVD/Video producers, distributors, broadcast networks, cable networks, syndication companies, local broadcast TV stations, cable system operators, and satellite distribution companies. Sellers may also include producers of other entertainment products such as video game developers, video game publishers, music labels, concert promoters, and live theater. Further, additional sellers may include sports teams and promoters.

Each of these sellers may be selling pre-production product placement opportunities where a product is actually used or displayed during a live event or while during the initial filming of a show. Alternatively, these sellers may also sell post-production product placement opportunities where a product may be digitally inserted into a film or television show after the initiation filming of the event.

Buyers of product placement advertisements may include almost any type of advertiser or company interested in advertising. These companies may include for example: advertising agencies, brand managers, marketing firms, public relations firms, retailers chain stores, consumer product manufacturers, pharmaceutical companies, product placement firms, e-Commerce websites, airlines, alcohol and beverage firms, magazine publishers and book publishers. Regardless of the type of company, the present invention will allow a potential advertiser to search and select product placement opportunities which are the most promising from them.

With reference to FIG. 3A, an embodiment of the product placement system 300 is provided. As illustrated in FIG. 3, the product placement system 300 may include a user registration module 302, a login processing module 308, an account management module 316, a product posting module 320, a program posting module 340, a matching module 380, a search module 390, and a data storage module 310. The data storage module 310 may be or include a database storing search results 312 and saved listings 314.

As illustrated in FIG. 3B, the registration module 302 may display a home page that allows a visitor to create a new account. The registration module 302 includes a biographic information collection component 304 and an account type selection component 306. The biographic information collection component 304 may prompt a visitor to input information such as name, company, title, type of business, address, phone, and email address. The biographic information collection component 304 may also prompt a user to select and confirm a password. The email address may be subsequently implemented as a unique user login. Thus, the biographic information collection component 304 may prompt a user to select another email address if the entered email address is already in use. The account type selection component 306 may pre-select or prompt the visitor to select a type of account. The account may include either a program account or a product account and “users” and “visitors” as described above may include both sellers and buyers, as appropriate to each component described herein.

With reference again to FIG. 3A, the login processing module 308 may be implemented to process registered users. If a user has already established an account by implementing the user registration module 302, the user can log in directly by selecting a link to access the login processing module 308. Users may select a “remember login” option to have user login information saved for a next visit. The login information including the user's email and password may be stored as a cookie in the user's web browser.

The account management module 316 facilitates management of user accounts. The account management module 316 may offer a user account data link that is individually selectable by each user. In embodiments of the invention, the user may edit account data, such as email address, password and other biographical information. However, the user cannot modify the type of account. Accordingly, program accounts cannot be changed to product accounts or vice versa.

The program posting module 340 allows a user to develop a potentially unlimited number of program listings. With reference to FIG. 3C, the program posting module 340 may include a program listing module 342 for facilitating selection and display of program attributes. The program listing module 342 may include a descriptive component 344 for displaying and allowing selection of multiple descriptive elements such as country, program name, program description, and program company. A program length selection component 346 may allow program length to be specified in minutes or in another format. For example, the program length may include one of a number of selectable options including: less than 15 minutes, 15 minutes, 30 minutes, 45 minutes, 60 minutes, 90 minutes, 120 minutes, and 180 minutes. The program listing module 342 may also enable selection of program status with a status selection component 347. Selectable options may include: in development or no production commitment; in production or shooting now; post production; or pre-production with a production commitment. Additional options may also be offered.

The program listing module 342 may also include a program coverage selection component 348 for selecting coverage. Coverage may be local, national, or regional.

The program listing module 342 may also include a program type selection component 350. The program type selection component may offer a menu or list of selectable program types. The selectable program types may include for example: all types; film; internet-webcasting; live concerts; live theater; mobile content; music videos; podcasting; print-magazines; print newspapers; radio; sports; television; or video games. Other program types may also be included.

The program listing module 342 may also include a time coverage selection component 352 for television. The time coverage selection component may offer selectable options including for example: all; morning or 6:00 AM to 9:00 AM; daytime or 9:00 AM to 4:00 PM; early fringe or 4:00 PM to 6:00 PM; access or 6:00 PM to 8:00 PM; prime time or 8:00 PM to 10:00 PM; late night or 10:00 PM to 2:00 AM; or other.

The program listing module 342 may also include a demographic delivery selection component 354. The demographic delivery selection component 354 may include selectable options by age and/or gender such as: kids 2-6; kids 6-11; tweens 8-12; teens 12-17; women 18-34; women 18-49; women 25-54; women 55+; men 18-34; men 18-49; men 25-54; men 55+; adult 18+; adult 18-34; adult 18-49: adult 25-54; and adult 55+. The demographic delivery selection component 354 may allow multiple options to be selected. Multiple options may be selected for example by using the CTRL key on a computer keyboard.

The program listing module 342 may also include a market selection component 356. The market selection component 356 may provide selectable options including: all ethnic and general markets; Hispanic ethnic market; African American ethnic market; Asian ethnic market; all ethnic markets; and all general markets.

The program listing module 342 may additionally include additional components 358, such as a ratings delivery component, a clearance list, a media kit, and a program website listing.

The program posting module 340 may also include a product seeking component 360. The product seeking component 360 allows user to add multiple product categories and associated information for each category. The information entered in the product seeking component is the primary information by which the matching module finds complementary products to the program listing. In embodiments of the invention, adding a product for entry in the product seeking component 360 opens a popup window in which various components allow selection of additional features.

The product seeking component 360 may also include a product category selection component 362 that allows selection of a product category. Product categories are typically controlled via an administrative interface constructed of a multi-tier parent/child hierarchy. In embodiments of the invention, the hierarchy is a three-tier hierarchy. Data stored in this hierarchy may be expanded to additional levels.

The product seeking component 360 may additionally include an exposure offering selection component 364 that may allow a user to select or enter exposures offered. Exposures may include for example: all; foundation for or integration into storyline; mention in dialogue; on air promos or trailers; other; used by audience, extras, and/or fans; used by talent; and incorporated in set design. Multiple exposures may be selected and in embodiments of the invention, multiple exposures may be selected by using the CTRL key on a keyboard.

An airdate selection component 366 may offer a selection of airdates by year, by quarter of year or other criteria. A product placement component 368 may offer a selection of types of product placements, such as for example, live integration, post-digital insertion, or both. A terms selection component 369 may include selectable options such as for example: barter or product only; barter and cash; cash only, or a combination of barter, cash, and spot purchase. A fee range component 370 may offer a selection of applicable fee ranges, such as for example, no fee, $1000 to $5000, $5001 to $10,000, $10,001 to $25,000, $25,001 to $50,000, and other higher fee ranges. A spot selection component 372 may allow selection of a number of spots required, such as for example, 1, 2, 3, or more than 3. A deal window 374 may also be included. The deal window 374 may offer multiple selectable date ranges during which the deal will remain open.

A decision making information component 376 may provide an opportunity to input and save a final decision maker name along with the decision maker's title and company. The decision making information component 376 may also receive and store names, titles, and companies of other decision makers.

A confirmation component 378 may include a staging page on which information entered through the program posting module 340 will be displayed for user review prior to submission. Users can select to save, edit, or save and search the entered information. The selection of the “save and search” option triggers the matchmaking process for searching stored data for corresponding products based on the criteria entered into the program posting module 340.

With reference to FIG. 3D, the product posting module 320 facilitates user creation for a potentially unlimited number of product listings. The product posting module may include a product listing module 321. The product listing module 321 may include a descriptive product component 322 for allowing entry of such information as country, product name, product description, and product company.

The product listing module 321 may also include a product category selection component 323 through which product categories may be dynamically controlled. The product category selection component 323 may include an administrative interface constructed of a three-tier parent/child hierarchy. Category data stored in the parent/child relationship may be expanded beyond three tiers if required.

The product listing module 321 may additionally include a demographic delivery selection component 324. The demographic delivery component 324 may include selectable demographic groups to whom the product is targeted. These groups may include for examples: kids ages 2-6; kids ages 6-11; tweens; ages 8-12; tweens ages 12-17; women ages 18-34; women ages 18-49; women ages 25-54; women ages 55+; men ages 18-34; men ages 18-49; men ages 25-54; and men ages 55+. In embodiments of the invention, multiple demographic delivery markets may be selected by using a keyboard CTRL key.

The product listing module 321 may additionally include a market selection component 325. The market selection component 325 may include selectable options for identifying a target market. The selectable options may include for example: all ethnic and general markets; Hispanic ethnic market, African American ethnic market; Asian ethnic Market; all ethnic markets; and general market.

The product listing module 321 may additionally include a program type selection component 326 that may allow selection of an identified program type for placement of the product. The program types may include for example: all types; film; internet webcasting; live concerts; live theater; mobile content; music videos; podcasting; print magazines; print newspapers; radio; sports; television; and video games.

The product listing module 321 may also include a target flight date selection component 327 that may allow selection of a target flight date based on year and quarter or other criteria.

The product listing module 321 may further include an exposure selection component 328 that may be implemented to select desired exposures for the product listing. Selectable exposure options may include for example: all; foundation for storyline or integration into storyline; mention in dialogue; on air promos or trailers; other; set design; used by audience, extras, or fans; and used by talent.

The product listing module 321 may also include a product placement selection component 329 may be implemented to select a desired type of product placement opportunity. Selectable types may include for example: live integration; post digital insertion; or both.

The product listing module 321 may implement a fee range selection component 330 for allowing selection of a desired fee range for the product placement. The fee range selection component 330 may offer a selection of applicable fee ranges, such as for example, no fee, $1000 to $5000, $5001 to $10,000, $10,001 to $25,000, $25,001 to $50,000, and other higher fee ranges.

The product listing module 321 may also include a program length selection component 331 that may offer selectable program lengths for the desired product placement. The selectable program lengths may include for example: less than 15 minutes, 15 minutes, 30 minutes, 45 minutes, 60 minutes, 90 minutes, 120 minutes, 180 minutes or other program length.

The product listing module 321 may also include a program status selection component 332. The program status selection component 332 enable selection of program status. Selectable options may include: in development or no production commitment; in production or shooting now; post production; or pre-production with a production commitment. Additional options may also be offered.

The product listing module 321 may additionally include a program coverage selection component 333 for selecting coverage. Coverage may be local, national, or regional. The product listing module 321 may also include a website link selection component 334 for selecting a product website for review.

The product posting module 320 may additionally include a decision making data storage component 335. The decision making data storage component 335 allows a user to enter information pertinent to decision makers related to the product posting. The information may include the name of a final decision maker, the decision maker's title and company, names of others involved in the decision making process, and title and company of others involved in the decision making process.

The product posting module 320 may additionally include a confirmation component 336. The confirmation component 336 may display all information about a product listing for user review. The user can select to save, edit, or save and search the information. Selection of the save and search option may trigger operation of the matching module 380 to search saved listings for corresponding programs based on the criteria set in the product listing.

After a program description has been entered along with sought products, the matching module 380 of the product placement system 300 may automatically display exact product matches as well as similar matches to the sought products. The matching module 380 bases its search on matching factors from the program listing. These factors, such as product categories, demographic delivery, and program types can be edited through the program posting module 320.

With reference to FIG. 3E, the matching module 380 may include an product exact match component 382 and a product similar match component 384. These components are operative upon entry of program information to find product matches. In particular, these components automatically find matches when the user selects the “save and search” option. Exact matches are based on listing criteria and product category selections. In addition, the exact matches represent products within the system that have selected the corresponding program attributes demonstrating a high matching likelihood. Paging control may be included to limit the number of results per page. Results may be shown in a report that has multiple storable columns. The columns may include a product name column, a product category column, a company column, and a date added column. The product name may be selectable in order to allow viewing of product details.

The product similar match component 384 may produce results that are similar based on the listing criteria but not identical. Results may be shown in a report having the same columns as those described above with respect to exact matches.

The matching module 380 may additionally include a program exact match component 386 and a program similar match component 388. These components are operative upon entry of product information to find a matching program. In particular, these components automatically find matches when the user selects the “save and search” option. After a new product listing is created these program match components 386 and 388 may automatically display matches. The search criteria implemented by the components 386 and 388 may include : country; program length; program status; program type; demographic delivery; program airdate or premier date; exposures offered; product placement opportunity; and/or terms.

The program exact match component 386 are exact matches based on the listing criteria and program category selections. These matches represent programs that have selected the corresponding product attributes demonstrating a very high likelihood of matching. Results may displayed in columns including program name, program type, venue, genre, company, and date added.

The program similar match component 388 may locate matches in the same manner as the program exact match component 386. Similar matches may be selected based on a threshold number of matching criteria and are displayed in the manner described above with respect to exact matches. The search module 390 may offer a product search component 392 and a program search component 394. Through the product search component 392, users can search directly for products without entering program information. By using this features, users are able to enter a broader matching search criteria. The search criteria may relate to product category, demographic delivery, program type, or other features.

Through the program search component 394, users can directly search for programs without entering all of the pertinent information about a product. Instead the user may enter a broader matching criteria. The matching criteria may relate to a matching country of the program, program length, program status, program type, demographic delivery, and/or premier date or air date. The matching criteria may also relate to exposures offered, product placement opportunity or deal terms.

A data storage module 310 which may be or include a database may store both search results 312 and listings 314. A user may view both saved program listings and saved product listings. Preferably, a navigation button or other option is provided for viewing saved listings. Saved program listings may be shown in a report having multiple columns showing a unique identifier, program name, program type, products seeking, date added, and date last modified. Options for reviewing, editing, and deleting program listings may be provided.

Similarly, the user may view saved product listings. The product listings may be shown in a report including a unique product identifier, a product name, a product category, a date added, and a date last modified. The product listings may also be displayed with options for reviewing, editing, and deleting.

Although the components described above are described as accommodating product placement opportunities, they may also be used to facilitate other business opportunities. For example, the above described components may facilitate sponsorship and promotional, opportunities.

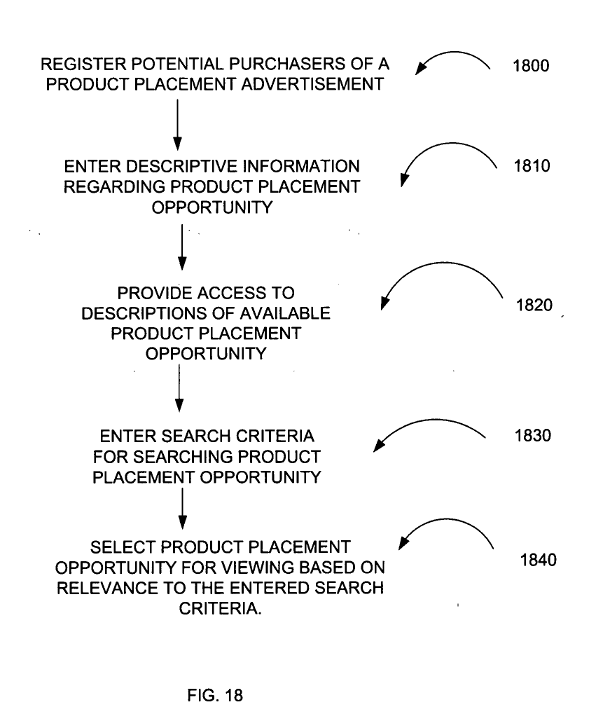

With reference now to FIG. 18, a preferred method of the present invention will now be discussed. Preferably, this method will be performed by computer program resident on a computer system which users may access via the Internet. Preferably, the computer system includes a server which may store and retrieve data to and from one or more databases.

As shown in Step 1800, a first preferred step of the present invention is to register potential purchasers of product placement advertisements. Preferably, this process will preferably include a data entry screen which sellers can use to enter pertinent business and contact information into displayed fields. According to a preferred embodiment, registered users preferably may receive a user ID and password for gaining future access to the computer program.

As shown in Step 1810, a second preferred step is to allow sellers to enter descriptive information regarding product placement opportunities. Preferably, this descriptive information may be entered through a series of drop-down menus and text fields. The descriptive information may preferably include a number of terms which will be of interest to potential buyers of product placement advertisements. According to a preferred embodiment, the descriptive information may include, for example: the name of the program in which the product placement opportunity exists, the type of media outlet for the product placement opportunity, the genre of the product placement opportunity, time and date of airing of the product placement opportunity, demographic information relevant to the product placement opportunity, and/or a narrative description of the program in which the product placement opportunity exists

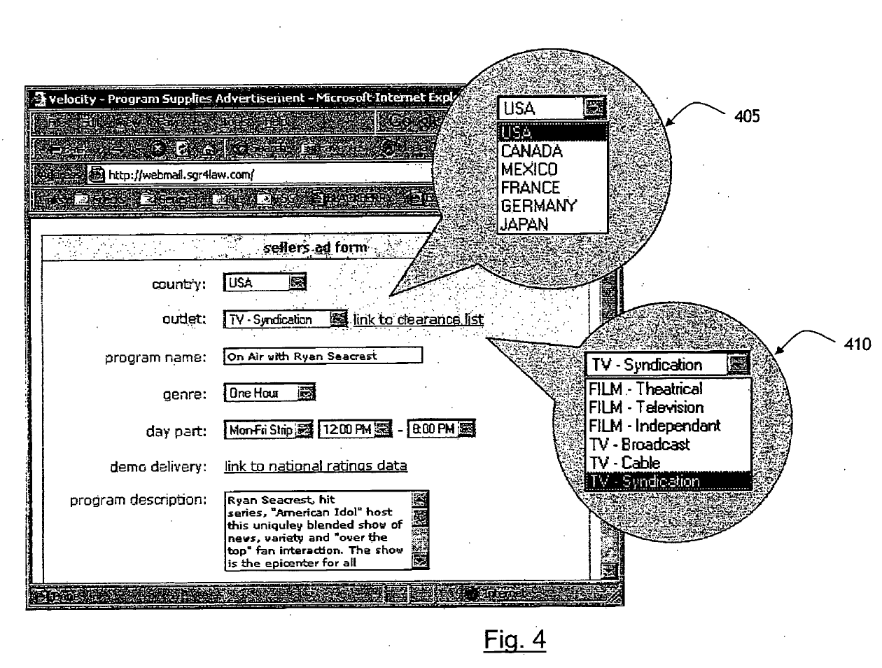

As shown in FIG. 4, the information may also include the relevant country for the product placement opportunity. This list of countries may be provided as a drop-down menu 405.

As further shown in FIG. 4, the information may also include the types of media outlets in which the product placement opportunity exists. These may be provided in a drop-down menu 410 and may include options such as: syndicated TV shows, cable TV shows, broadcast TV shows, independent films, television films, theatrical films or other types of media outlets.

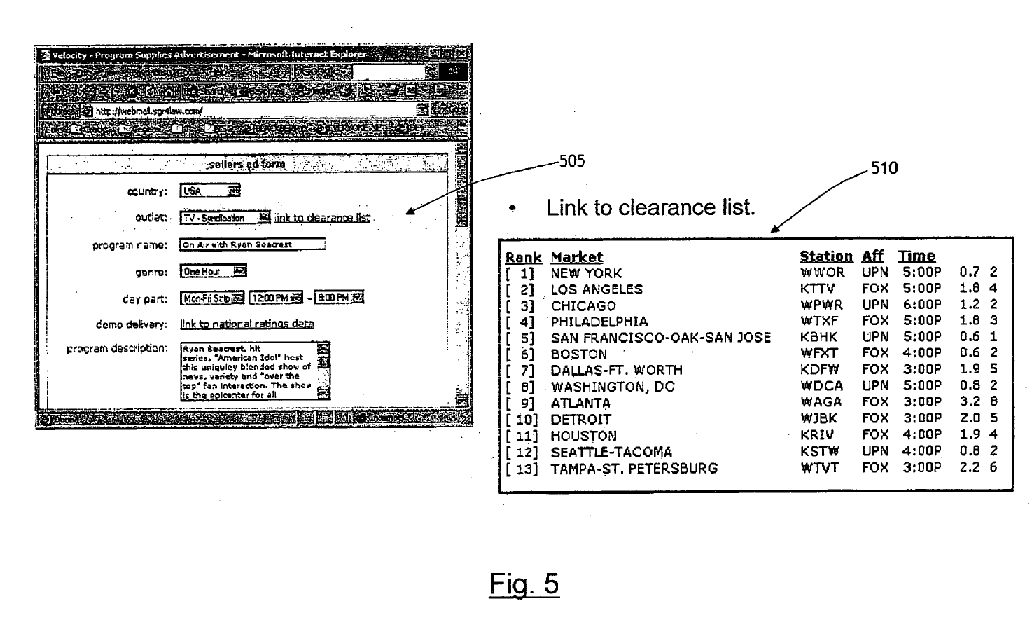

As shown in FIG. 5, access to a clearance list 510 showing relevant market and station information for the product placement opportunity may be provided. This access may be provided via a link 505 or, alternatively, via a searchable database.

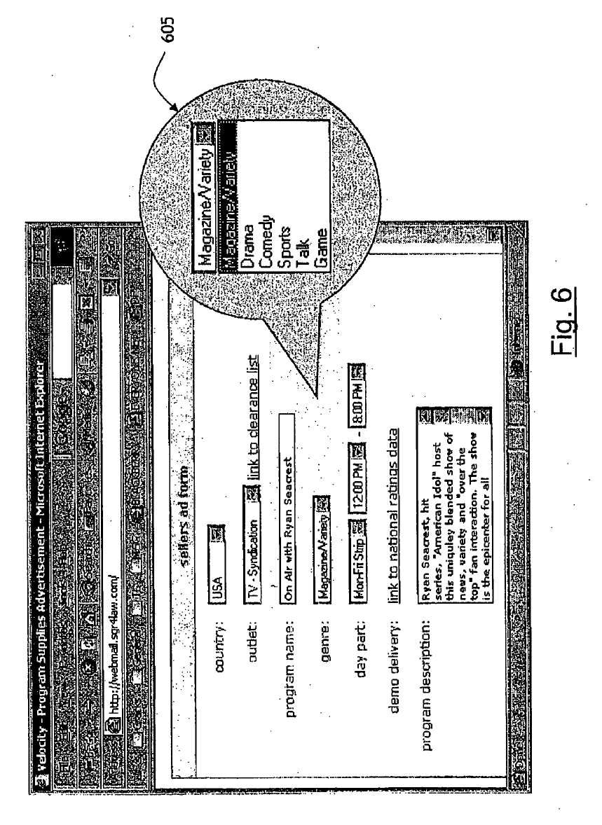

As shown in FIG. 6, the type of genre for a product placement opportunity may be provided in a drop-down menu 605. The types of genre which may be used may include options such as: drama, comedy, sports, talk, game, magazine and variety.

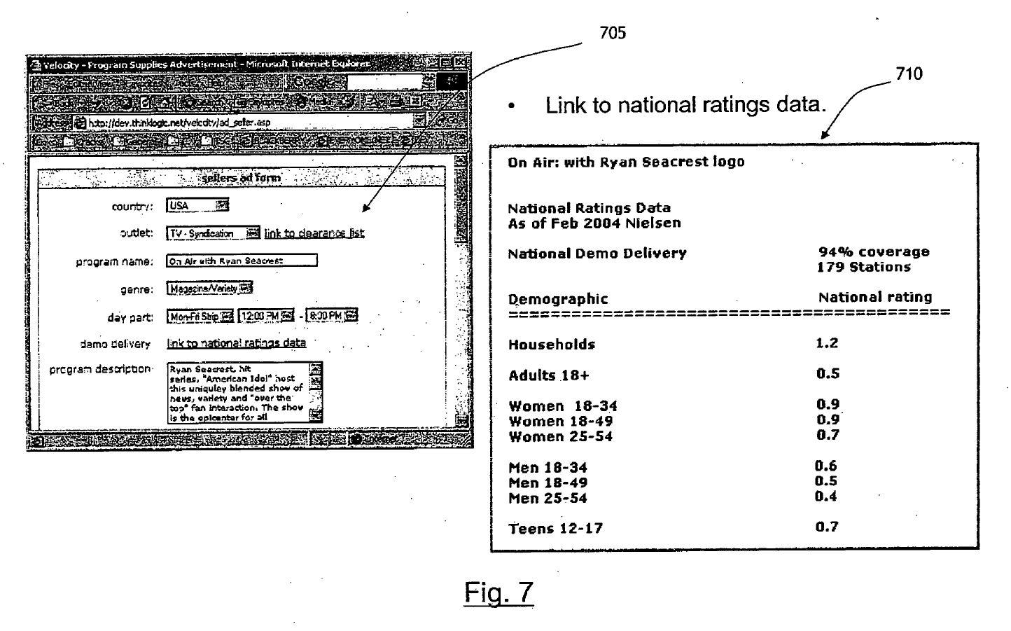

As shown in FIG. 7, a demographic information 710 relevant to the product placement opportunity may also be provided. This access may be provided via a link 705 or, alternatively, via a searchable database.

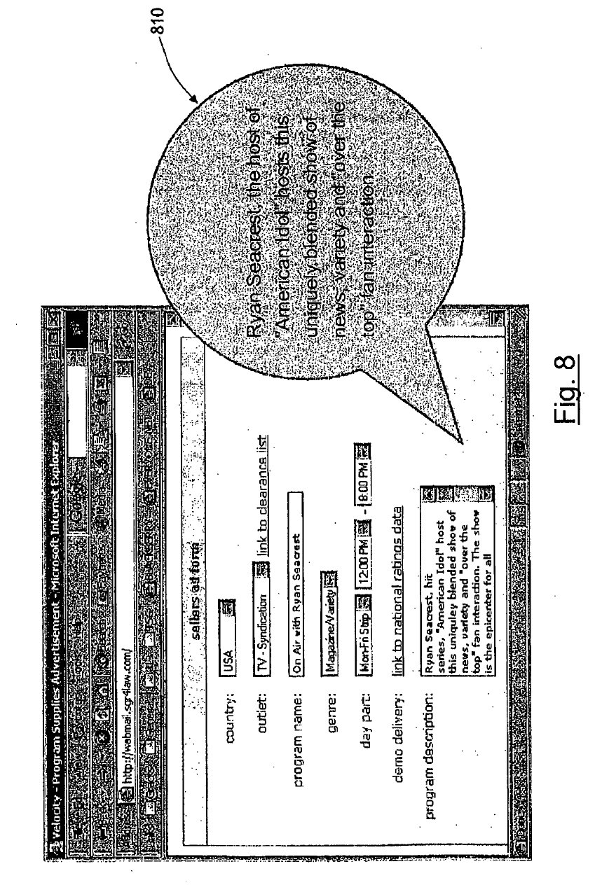

As shown in FIG. 8, a narrative description 810 of a program offering a product placement opportunity may also be provided. This narrative description preferably is searchable via a text searching tool.

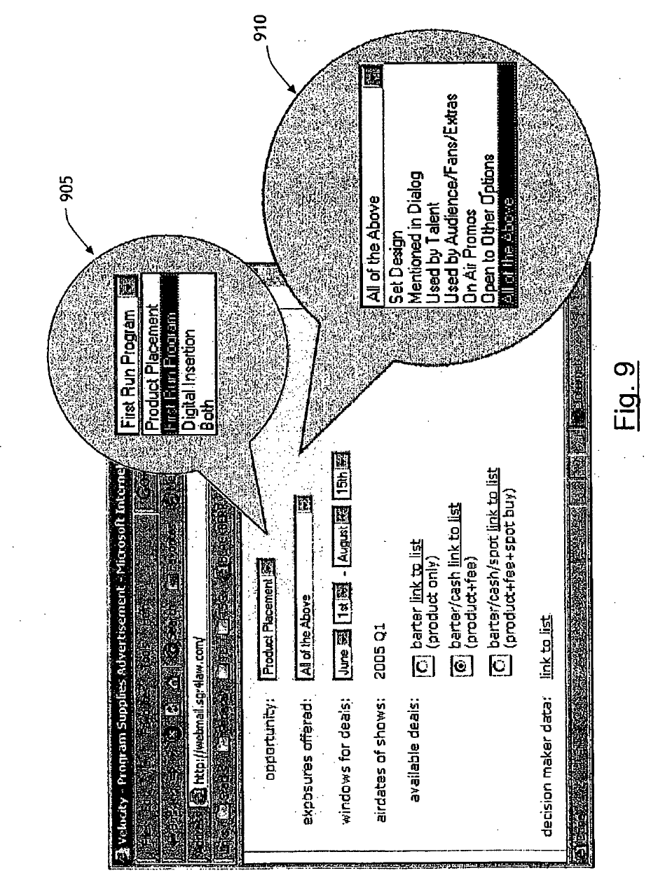

As shown in FIG. 9, a further description of the product placement opportunity may also be provided to allow users, for instance, to specify whether the product placement opportunity occurs within a first run program, a re-run program, and/ or whether it is for a traditional product placement (i.e. use of an actual product) or a proposed digital insertion of a product or advertisement. This list of choices may be provided via a drop-down menu 905.

As further shown in FIG. 9, a description may be provided which details how a proposed product will be used within given product placement advertisement. These descriptions may include, for instance, how a product is proposed to be used in a product placement, such as: in the set design, mentioned in dialog, used by an actor, used by an extra, used in a related promotion, and whether any other options are available. This list of choices may be provided via a drop-down menu 910.

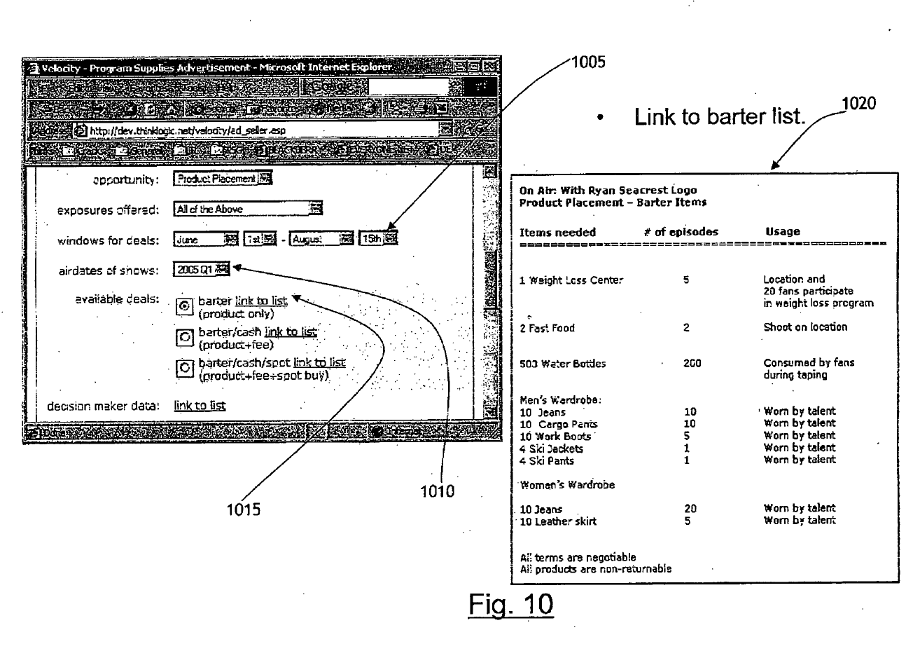

As shown in FIG. 10, the descriptive information may also include date range or window of agreeing to deals for product placement opportunity. This list of choices may be provided via a drop-down menu 1005.

As further shown in FIG. 10, the descriptive information may also include the airdate of the show in which the product placement opportunity is available. This information may also be selected via a drop-down menu 1010.

As further shown in FIG. 10, in addition to the descriptive terms listed above, sellers may preferably also provide the commercial terms under which they would be willing to sell a product placement advertisement. These terms may include the price the seller is charging for a product placement advertisement. Additionally, these terms may also options to purchase a product placement advertisement for barter. Under this arrangement, a seller may advertise that they are willing to sell a product placement advertisement (i.e. showing or using a specific type of car in a movie) in exchange for the free use of the product in the production. Such a choice may be provided via a link 1015 to a descriptive list of barter product placement opportunities 1020.

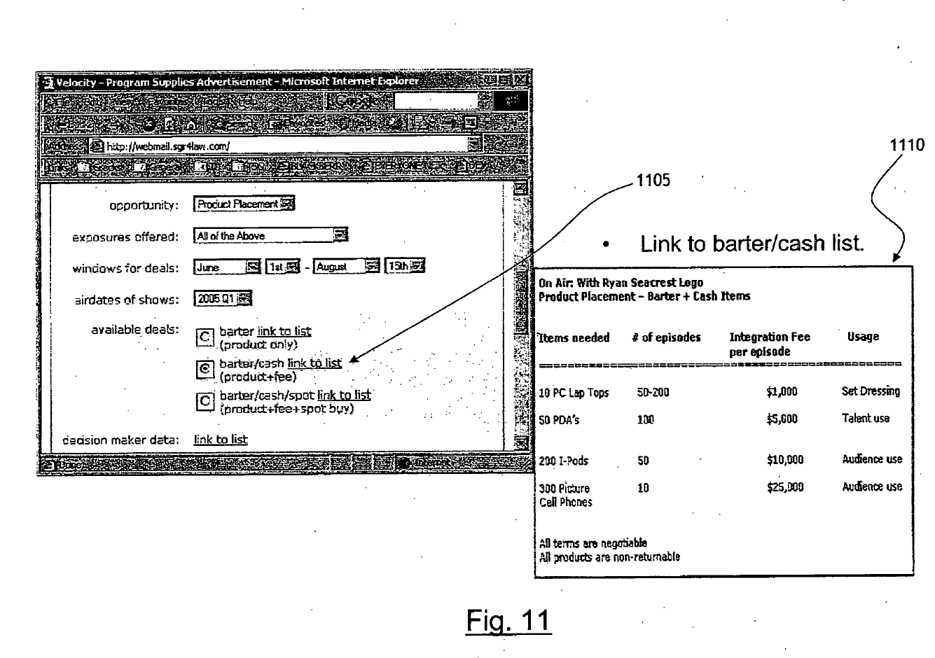

As shown in FIG. 11, the prospective commercial terms for a product placement opportunity may also include an option of having a barter arrangement which includes a product placement fee. As shown, such a choice may be provided via a link 1105 to a descriptive list of barter-plus-fee type product placement opportunities 1110.

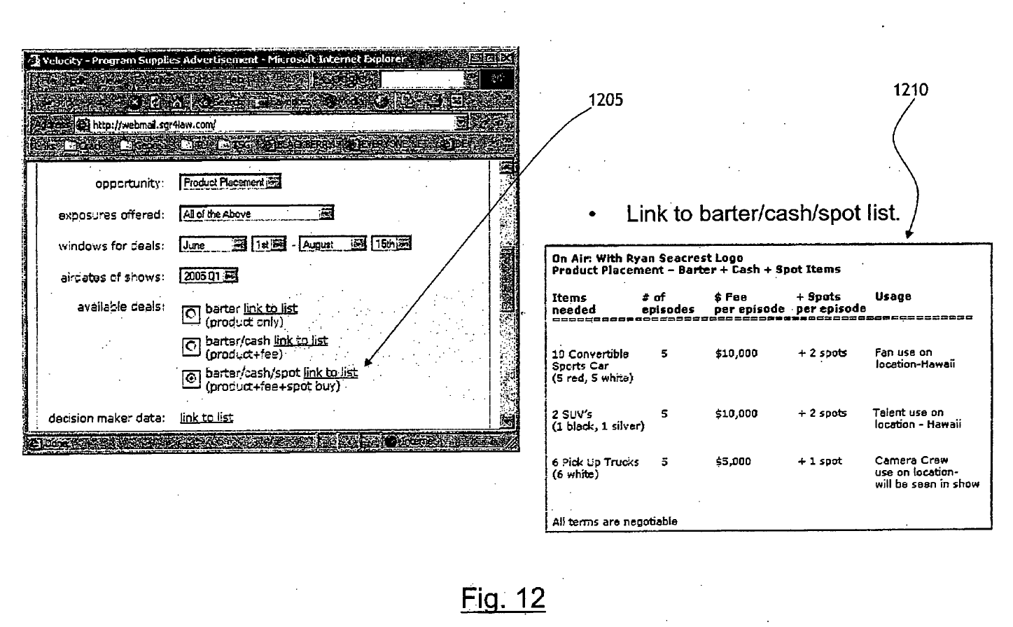

As shown in FIG. 12, further, the commercial terms may include an option for an arrangement which offers the purchase of a product placement advertisement in exchange for barter, payment of a fee, and an agreement to by a traditional advertising spot. As shown, such a choice may be provided via a link 1205 to a descriptive list of barter-fee-spot type product placement opportunities 1210.

Additionally, numerous other types of commercial terms and arrangements may be provided by sellers and made searchable for buyers.

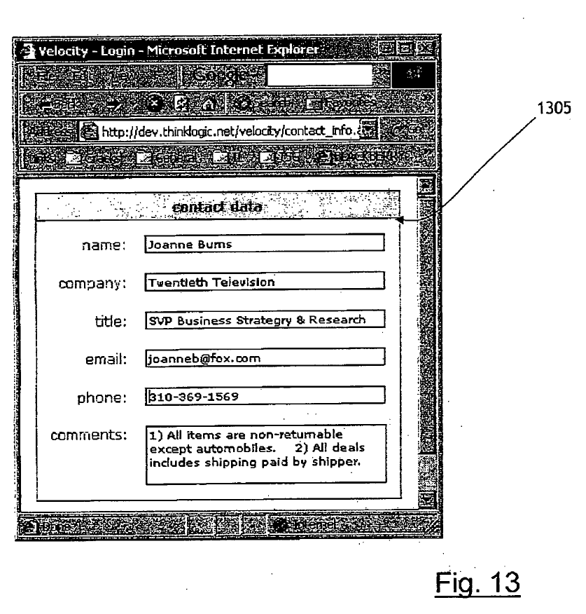

With reference now to FIG. 13, according to a further preferred embodiment, sellers may also provide contact information 1305 and decision maker information for each product placement opportunity.

Referring back to FIG. 18, once selling data is entered into the system for a product placement opportunity, as shown in Step 1820, a third preferred step of the present invention is to provide users access to descriptions of the available product placement opportunities. Preferably, this access is provided via an Internet connection which displays listings of product placement opportunities via an HTTP or similar connection.

With further reference to FIG. 18, a fourth preferred step, Step 1830, of the present invention provides users the opportunity to enter specific search criteria. Preferably, this search criteria is designed to include terms corresponding to the descriptive information-entered by the sellers. Accordingly, it is preferable that search criteria include data such as the price of the product placement opportunity, the type of product, type of spot, type of media outlet, date of product placement opportunity, time of day of product placement opportunity and the genre of the product placement opportunity. Further, it is preferable that the search criteria include data such as the commercial terms available for securing a product placement opportunity and preferred target demographics.

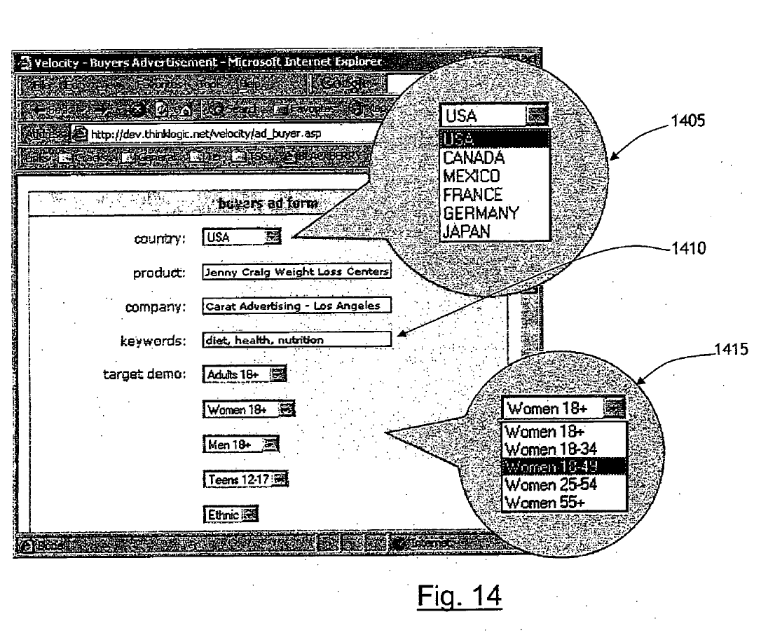

As shown in FIG. 14, buyers may enter search criteria such as the desired country 1405 and the target demographic 1415. Further, the search criteria may include key words 1410 which can be used to search descriptive information provided by sellers.

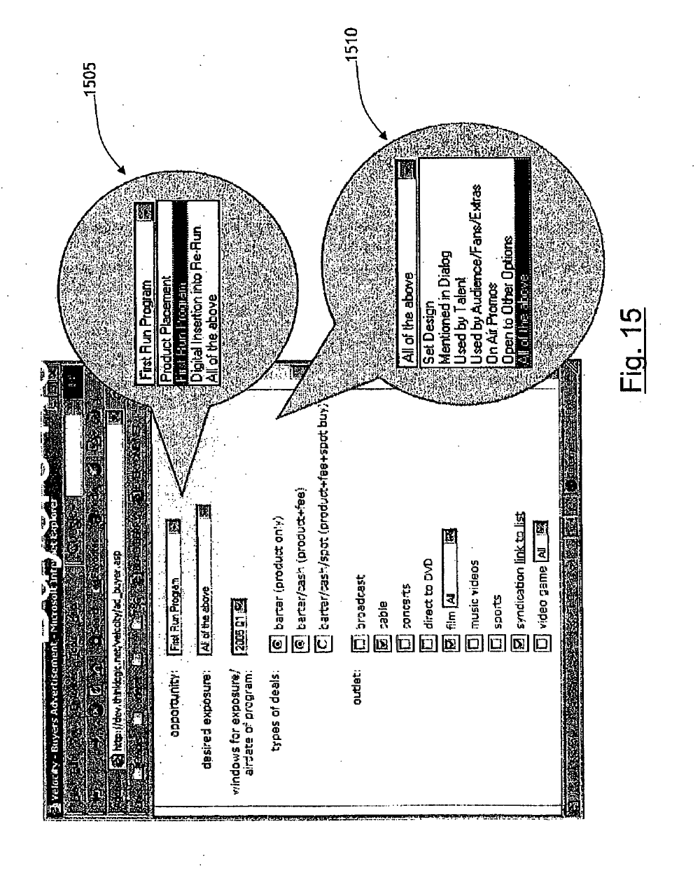

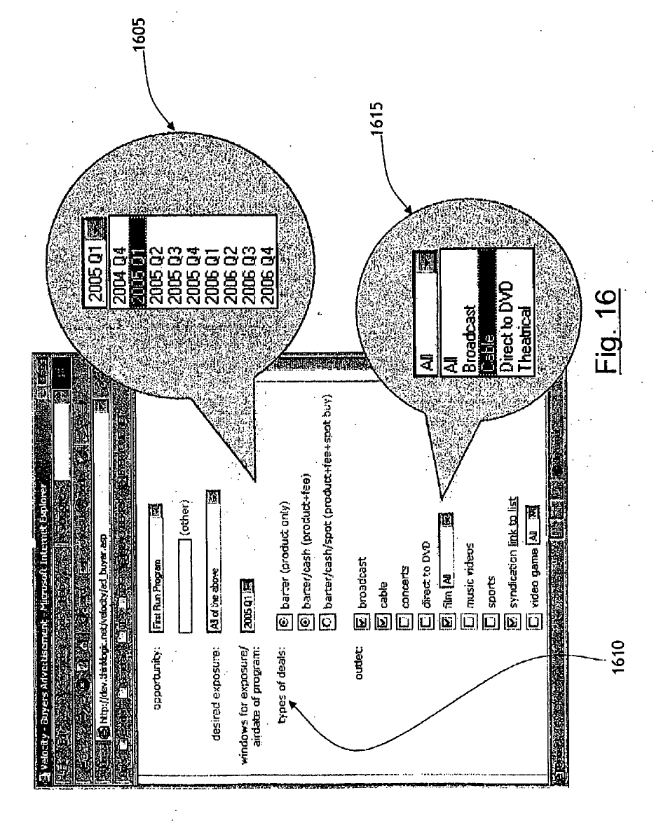

With reference to FIGS. 15, and 16, additional search criteria preferably corresponding to the descriptive information entered by the participating sellers of product placement advertisements may also be entered by a perspective buyer. These criteria may include, for instance: whether product placement opportunity occurs within a first run program, a re-run program, and/ or whether it is a traditional product placement or digital insertion of a product 1505; how a proposed product will be used 1510 within given product placement advertisement; the date range or window for deals and airdates for programs 1605; types of commercial terms available to purchase a product placement advertisement 1610 (i.e. barter, barter+fee, barter+fee+spot); and the type of media outlet 1615 expected to be used. Finally, it is preferably that buyer contact and decision maker information is provided.

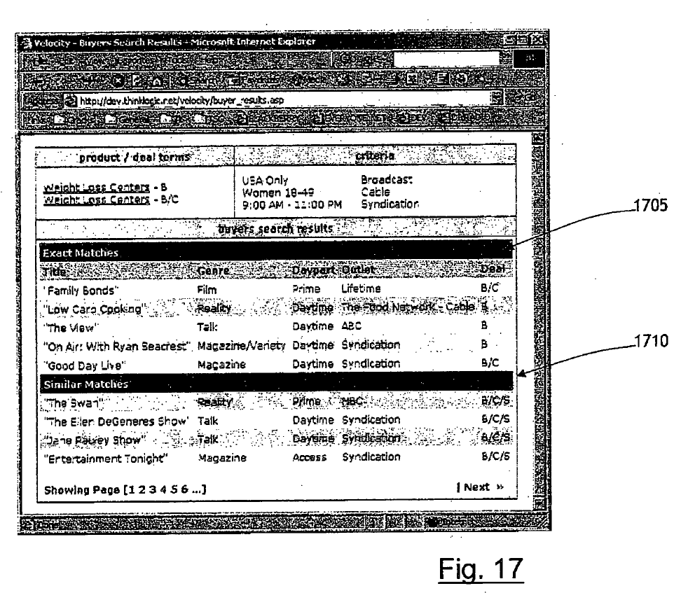

Referring back to FIG. 18, in Step 1840, once the search criteria is entered, the search criteria may then be compared to the entered descriptive information to select the most relevant product placement opportunities for viewing by the potential buyer. As shown in FIG. 17, this information is preferably presented in chart form showing exact matches 2005 and similar matches 2010 based on similarities between the descriptive information entered by the buyers and search criteria entered by the seller.

While the invention has been described in terms of its preferred embodiments, it should be understood that numerous modifications may be made thereto without departing from the spirit and scope as defined in the appended claims For instance, potential promotions and sponsorship opportunities may also be included, described and searched for like product placement opportunities. Likewise, licensing opportunities may also be included with descriptions and search terms germane to each market.

What is claimed is:

1. A computer-implemented system for facilitating product placement advertising, the system comprising:
a user registration module including an account type selection component for allowing a user to select one of a buyer account and a seller account, wherein a buyer account allows product posting and a seller account allows program posting;
a program posting module for allowing sellers to post program information and desired product information;
a product posting module for allowing buyers to post product information and desired program information; and
a matching module for providing matching posted products upon entry of a program posting and for providing matching posted programs upon entry of a product posting.

2. The system of claim 1, wherein the program posting module comprises a program listing module for allowing entry of program information.

3. The system of claim 2, wherein the program listing module comprises a descriptive component for allowing entry of a program country, a program description, a program company, and a program name.

4. The system of claim 2, wherein the program listing module comprises a length selection component for allowing selection of a program duration.

5. The system of claim 2, wherein the program listing module comprises a coverage selection component for selecting one or national, regional, and local program coverage.

6. The system of claim 2, wherein the program listing module comprises a demographic delivery component for allowing selection of a target program group by age and gender.

7. The system of claim 2, wherein the program listing module comprises a market selection component that allows selection of a target market by ethnicity.

8. The system of claim 1, wherein the program posting module comprises a product seeking component for allowing entry of desired product information including a type of product exposure offered, a product air date, and a fee range.

9. The system of claim 1, wherein the product posting module comprises a product listing module for allowing entry of descriptive product information.

10. The system of claim 9, wherein the product listing module comprises a product category selection component, a demographic delivery selection component, and a market selection component.

11. The system of claim 10, wherein the product listing module further comprises a program type selection component for allowing selection of a program type and an exposure selection component for allowing selection of a type of exposure including one of integration into storyline, use by audience, use by extras, use by talent, and incorporation in set design.

12. The system of claim 1, wherein the matching module comprises a product exact match component and a product similar match component for operation upon entry of a program listing.

13. The system of claim 12, wherein the matching module comprises a program exact match component and a program similar match component for operation upon entry of a product listing.

14. A computer-implemented method for facilitating product placement advertising, the method comprising:
providing a registration module for allowing users to enter biographical information and register for an account type, the account type including one of a program account and a product account;
offering a program posting module for allowing owners of a registered program account to post program information;
supplying a product posting module for allowing owners of a registered product account to post product information; and
automatically producing matching products upon receipt of a program posting and automatically producing matching programs upon receipt of a product posting.

15. The method of claim 14, wherein offering a program posting module comprises offering a descriptive component for allowing entry of a program country, a program description, a program company, and a program name.

16. The method of claim 14, further comprising including a length selection component for allowing selection of a program duration in the program posting module.

17. The method of claim 14 further comprising providing a coverage selection component for selecting one or national, regional, and local program coverage.

18. The method of claim 14, further comprising providing a demographic delivery component for allowing selection of a target program group by age and gender.

19. The method of claim 14, further comprising providing a market selection component that allows selection of a target market by ethnicity.

20. The method of claim 14, further comprising incorporating a product seeking component in the program posting module for allowing entry of desired product information including a type of product exposure offered, a product air date, and a fee range.

21. The method of claim 14, further comprising providing the product posting module with a product category selection component, a demographic delivery selection component, and a market selection component.

22. The method of claim 21, further comprising providing the product posting module with a program type selection component for allowing selection of a program type and an exposure selection component for allowing selection of a type of desired exposure including one of integration into storyline, use by audience, use by extras, use by talent, and incorporation in set design.

23. The method of claim 14, further comprising producing product exact matches and product similar matches automatically upon entry of a program listing.

24. The method of claim 23, further comprising providing program exact matches and program similar matches automatically upon entry of a product listing.

25. A computer-implemented system for facilitating product placement advertising, the system comprising:
a program posting module for allowing sellers to post program information;
a product posting module for allowing buyers to post product information;
a matching module for automatically providing matching posted products upon entry of a program posting and for automatically providing matching posted programs upon entry of a product posting; and
a search module for allowing sellers to search for products to incorporate in a program by selected product criteria and allowing buyers to search for a program for feature of a product by entry of selected program criteria.
